(19) United States
(12) Patent Application Publication
(10) Pub. No.: US 2004/0166290 A1
(43) Pub. Date: Aug. 26, 2004

(54) Process for laminating plies of tissue paper and laminated tissue paper

(75) Inventors: Dirk Sembritzki, Mannheim (DE); Jan-Peter Brunback, Mannheim (DE); Wolfram Schinkoreit, Unterabsteinach (DE)

Correspondence Address: YOUNG & THOMPSON, 745 SOUTH 23RD STREET 2ND FLOOR, ARLINGTON, VA, 22202

(73) Assignee: SCA HYGIENE PRODUCTS GMBH, MANNHEIM (DE)

(21) Appl. No.: 10/729,905

(22) Filed: Dec. 9, 2003

Related U.S. Application Data
(60) Provisional application No. 60/431,747, filed on Dec. 9, 2002.

(51) Int. Cl. B32B 31/00

(52) U.S. Cl. 428/179; 156/152; 156/209

(57) ABSTRACT

In a process for laminating plies of tissue paper, at least two plies of tissue paper are combined and are embossed together in at least one embossing nip so that they are provided with substantially identical embossing patterns which consist of embossing protrusions. The embossed plies are then separated, and the separated plies are then displaced relatively to each other and are recombined. In the resultant recombined tissue, the maximum distance D in the displacement direction between an embossing protrusion of a first ply and an embossing protrusion of a second ply, which has been displaced relatively to said first ply, is set as a function of the height H of the embossing protrusions and the length L of the embossing protrusions in the displacement direction of the two plies, so that D is equal to the smaller one of the values of 12H and 14L.

### TECHNICAL FIELD

The present invention relates to a process for laminating plies of tissue, and to a laminated tissue paper.

It is known to create bulk in a hygiene paper product, e.g. toilet paper, household towels, hand wipes, handkerchiefs, napkins, serviettes or the like by embossing. Embossment patterns are produced by feeding tissue plies through at least one embossing unit. Subsequently, the tissue plies are generally ply bonded to produce, for example, a 2-ply or a 4-ply tissue paper.

The creation of bulk by embossing is limited by various factors. The depth of the pattern, the hardness of the backing roll in an embossing unit for steel/rubber embossing, the type of embossing pattern, if union embossing is used and, last but not least, the tissue paper itself are all factors which can limit the bulk that is achievable in a hygiene paper product.

### PRIOR ART

EP-A-0,344,056 describes a process and apparatus for producing a multi-ply embossed fibrous sheet. Separate non-woven fibrous webs are combined into a multi-ply sheet before embossment, embossed as a multi-ply sheet, the embossed webs separated from one another and longitudinally displaced relative to one another, and then recombined into an embossed multi-ply sheet with the embossments out of register with one another. However, the disclosed process results in a multi-ply sheet with a thickness essentially the same as that embossed with the same pattern and not separated and recombined in a displaced manner after embossing.

U.S. Pat. No. 3,668,055 discloses superimposed embossed packaging sheets. A series of sheets of relatively heavy paper or similar matted fibrous materials are embossed and then passed through shorter or longer paths of travel before again being assembled so that their matching mounds and recesses are offset in such a manner that they no longer match. The disclosed method is, however, designed for kraft paper and is not suitable for tissue paper.

Generally, the superimposed sheets are intended to be offset so that nesting of the embossing protrusions of the respective plies is prevented. However, depending on the spacing between the embossing protrusions, there may be a tendency toward partial nesting of the embossing protrusions, leading to a decrease in the thickness of the superimposed embossed sheets.

### SUMMARY OF THE INVENTION

The object underlying the present invention is to provide a process for laminating plies of tissue paper, as well as a laminated tissue paper, of the above mentioned kind, wherein bulk is increased in an easy manner.

According to the invention, at least two plies of tissue as it is used for manufacturing hygiene paper products, for example toilet paper, household towels, or the like, are combined and embossed together with one and the same embossing nip. Both plies are provided with substantially the same embossing pattern consisting of embossing protrusions. The protrusions of the ply which is nearest to the embossing roll stack backwards into the indentations (protrusions) of the second ply. The generated bulk of the paper depends on the height of the protrusions, i.e. the embossing depth.

In accordance with the invention, the plies are then separated, for example in a so-called separating nip, and subsequently merged (recombined), for example, in a so-called merging nip. The embossing protrusions of the plies extend in the same direction. The path length for each individual ply between separation and merging is set to be different. According to the present invention, the maximum distance D in the displacement direction between an embossing protrusion of a first ply and an embossing protrusion of a second ply, which has been displaced relatively to said first ply, is set as a function of the height H of the embossing protrusions and the length L of the embossing protrusions in the displacement direction of the two plies, so that D is equal to the smaller one of the values of 12H and 14L. The embossing displacement can be subsequently fixed by any conventional, well-known ply bonding technique. In this manner, by setting the phase displacement between the tissue paper plies at a specified value such that the embossing patterns of the respective plies are not in register, and recombining the plies with this displacement, the resulting laminated tissue paper has an increased thickness, which creates more volume in the product. Thus, according to the invention, an improved laminated tissue paper or sheet and process of manufacturing same in an easy and reliable manner is provided while simultaneously increasing the bulk as compared to conventional techniques and products.

The embossing protrusions of the respective tissue plies are reliably prevented from nesting, and the recombined tissue paper has an increased volume as compared to the two plies the protrusions of which are in register, before having displaced the plies. Moreover, the defined distance D in the displacement direction between an embossing protrusion of a first ply and an embossing protrusion of a second ply prevents the unembossed areas on one ply from being pressed down under the effect of gravity by the embossing protrusions of the other ply.

The higher bulk gives an improved sensation of bulk softness, a critical feature for the feeling of softness. The increase in thickness moreover creates a textile-like appearance which is a very desirable feature of high quality tissue paper products.

The plies of laminated tissue paper may then be ply bonded in a mechanical or adhesive ply bonding process which is per se known in the art. Mechanical ply bonding can e.g. be achieved by application of high pressure in an additional embossing nip or the like. Ultrasonic welding can also be used for ply bonding (see U.S. patent application Ser. No. 60-341803). In the case of adhesive ply bonding, the glue can be added to all the protrusions of one ply or to just some of them. The paper can also be further embossed in a further embossing nip.

On one side of the recombined tissue, the embossing protrusions will extend outwards. This might slightly impair the aesthetic appearance and the haptics of the product. To avoid this, another ply, either unembossed or embossed, can be joined to the laminate. In case an embossed ply is used, the embossing protrusions thereof ought to be directed inwards.

### BRIEF DESCRIPTION OF THE DRAWINGS

The invention will be explained below with reference to the attached schematic drawings, wherein:

FIGS. 1 to 5 show five different apparatuses for carrying out the process according to the invention;

FIG. 6 shows a laminated tissue paper according to the invention, a) before displacing the two plies and b) after displacing the two plies; and

FIG. 7 shows an apparatus for carrying out a conventional tissue laminating process, without displacing the plies.

### DESCRIPTION OF THE PREFERRED EMBODIMENTS

Preferred, exemplary embodiments of the process according to the invention will now be explained with reference to the Figures, wherein like elements are shown with the same reference signs.

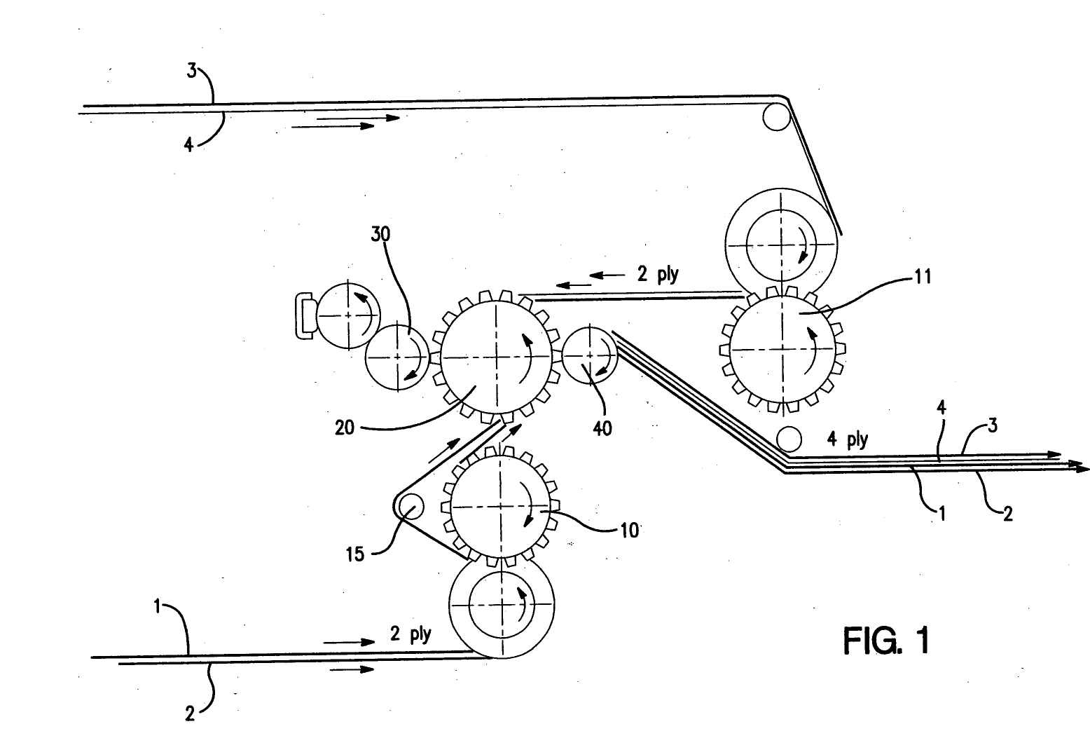

FIG. 1 shows a first embodiment of an apparatus for carrying out the process according to the invention. The apparatus serves for embossing and combining four plies 1, 2, 3, 4 of tissue in the form of a fibrous web, and operates as follows. Two plies 1, 2 are combined and fed to a bottom embossing roll 10 by means of which they are embossed in combination. The two plies 1, 2 are embossed with one and the same nip and, therefore, provided with the same embossing pattern consisting of embossing protrusions. The protrusions of the ply 2 which is nearer to the embossing roll 10 stack into the protrusions of the other ply 1.

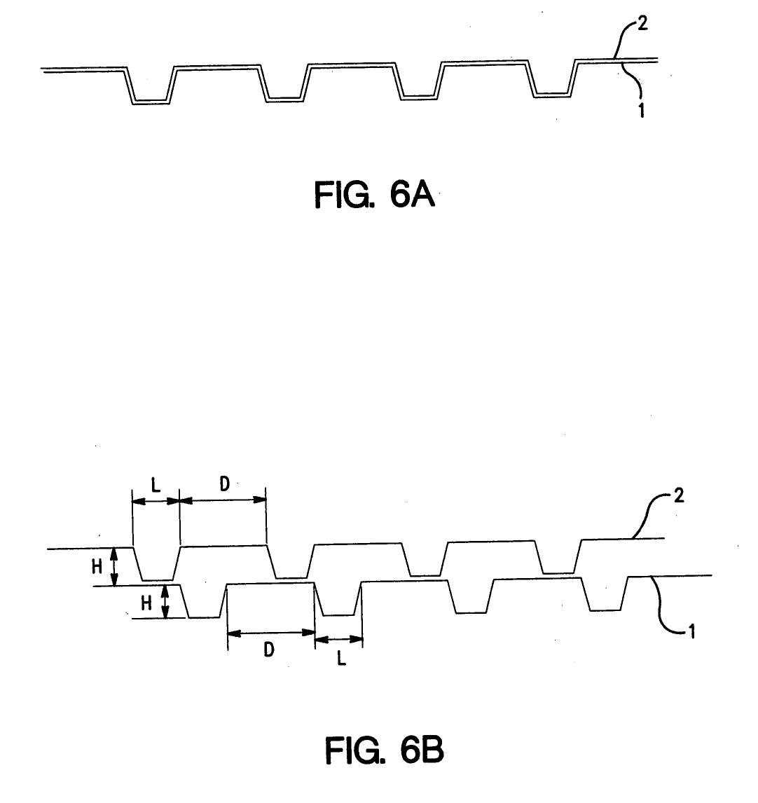

The embossed tissue plies 1, 2 are then separated and displaced relatively to one another so that the embossing protrusions are not in register with each other. In this first embodiment, this displacement or phase difference between plies 1 and 2 is effected by passing ply 1 over a deviating roll 15 so that it travels along a longer path than ply 2. Although it does not follow directly from FIG. 1, the maximum distance D in the displacement direction between an embossing protrusion of the first ply 1 and an embossing protrusion of the second ply 2, which is displaced relatively to said first ply 1, is set as a function of the height H of the embossing protrusions and the length L of the embossing protrusions in the displacement direction of the two plies 1, 2, so that D is equal to the smaller one of the values of 12H and 14L (see also FIG. 6, which will be explained in more detail further below).

Subsequently, the plies 1, 2 are recombined at a merging roll which, in this case, is a design roll 20. Thus, plies 1 and 2 are recombined such that their respective embossing patterns are no longer in phase, i.e. out of register, to the degree that D is equal to the smaller one of the values of 12H and 14L.

Meanwhile, two further plies 3, 4 are fed to a top embossing roll 11 and are also embossed in combination. Afterwards, they are also fed to the design roll 20. A glue application roll 30 is provided for applying glue to the upper one of the plies 3, 4. It is to be noted that design roll 20 can also correspond to a further embossing roll to apply a further embossing pattern to all the plies 1 to 4. Subsequently, the plies 3, 4 are fixed to the previously mentioned plies 1, 2 at a marrying roll 40. The resultant 4-ply sheet, comprising the two embossed, relatively displaced plies 1, 2 and the two further plies 3, 4 which are also embossed, is then discharged from the apparatus.

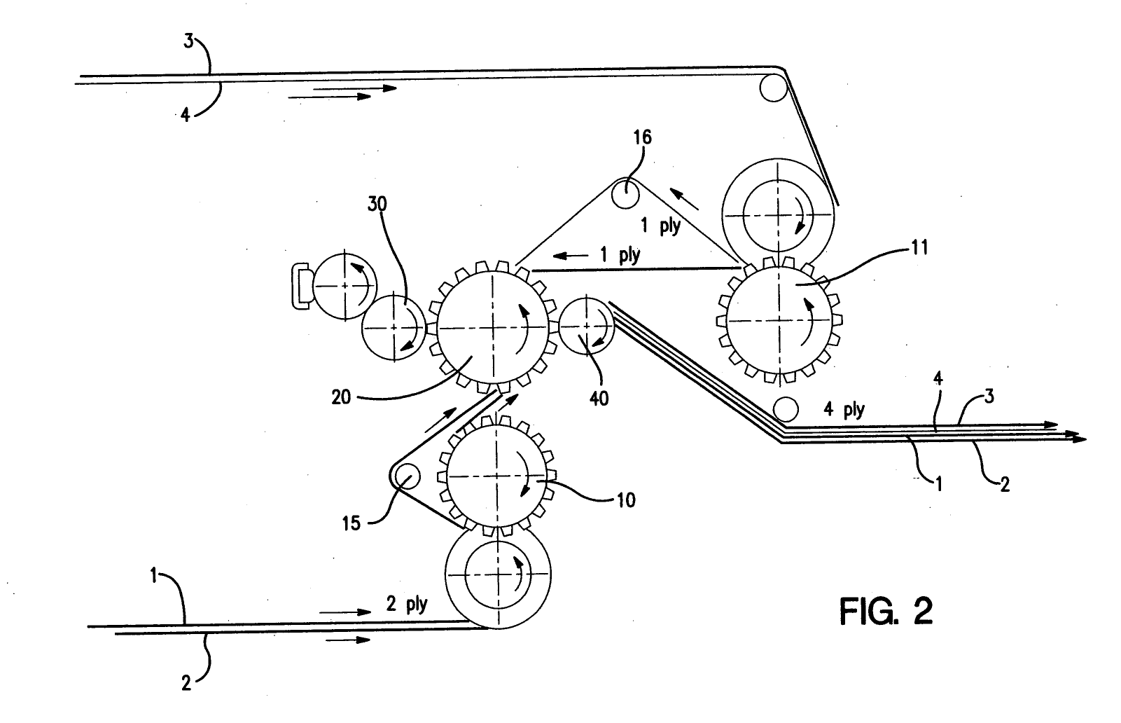

An alternative apparatus for carrying out the process according to a second embodiment of the invention is shown in FIG. 2, which is a modification of the process of FIG. 1. In this modification, by means of passing ply 4 over a deviating roll 16 after plies 3 and 4 have been embossed in combination, the further plies 3, 4 are also separated and displaced relatively to each other, in a similar manner as in the case of ply 1. In this manner, also the bulk of the plies 3, 4 is increased so that the overall bulk of the resultant 4-ply tissue is even greater than that produced in the apparatus of FIG. 1.

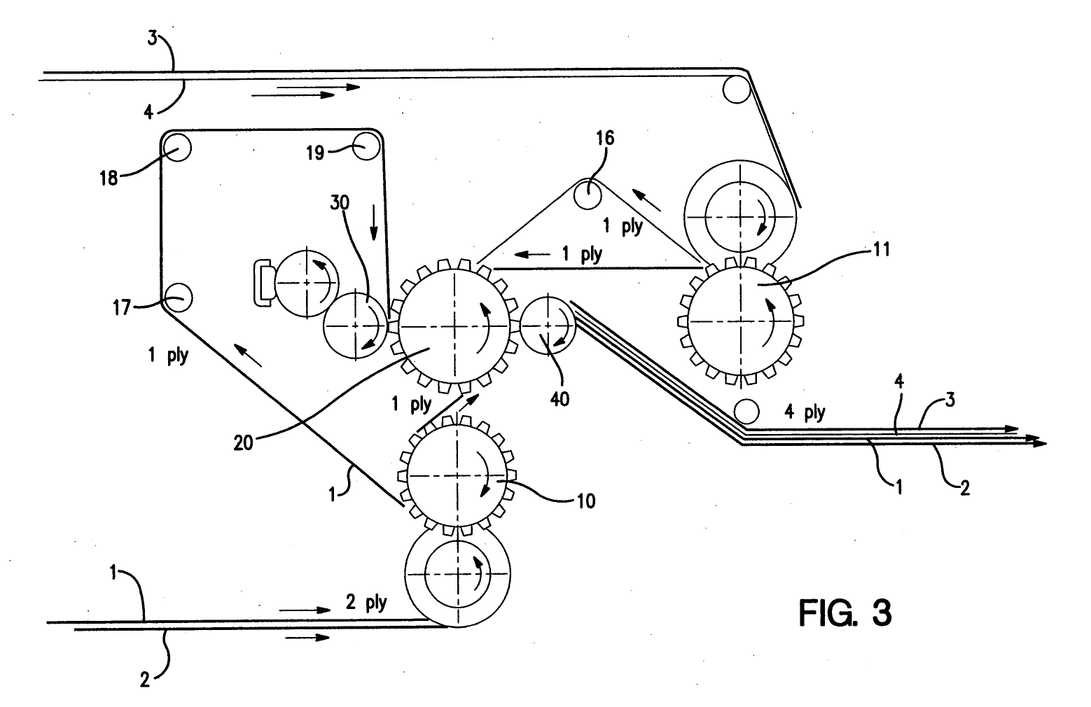

As becomes clear from a third embodiment of the present invention, as a modification of the second embodiment and shown in FIG. 3, one of the first plies 1, 2 can also be directed to the glue application roll 30 by means of further deviating rolls 17, 18 and 19. Glue is then applied to ply 1 before ply 1 is recombined with ply 2, to ply bond plies 1 and 2.

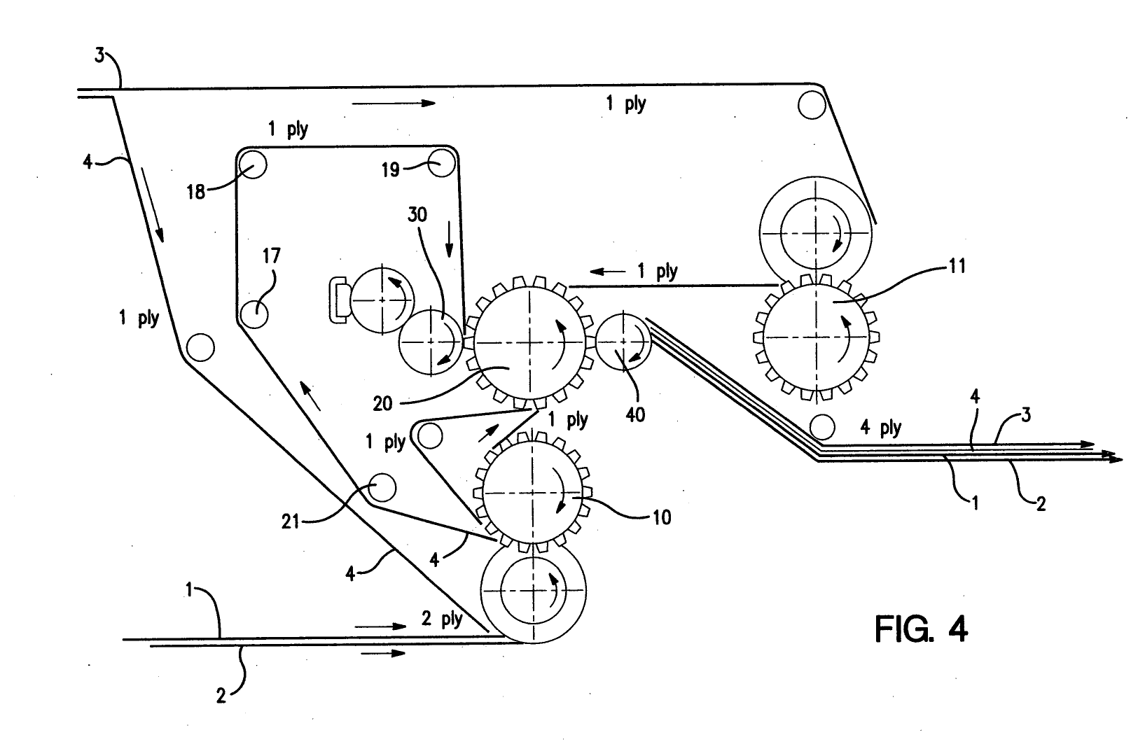

FIG. 4 shows a fourth inventive embodiment in an arrangement wherein plies 1, 2 and 4 are simultaneously fed to the bottom embossing roll 10, while only ply 3 is fed to the top embossing roll 11. In this modification, the same embossing pattern is applied to plies 1, 2 and 4, while a different pattern may be applied to ply 3. After embossing, plies 1, 2 and 4 are separated by means of deviating rolls 15 and 17, 18, 19 and 21, respectively, and glue is applied to ply 4 by means of the glue application roll 30. The four plies 1, 2, 3, 4 are then recombined at the design roll 20 and marrying roll 40.

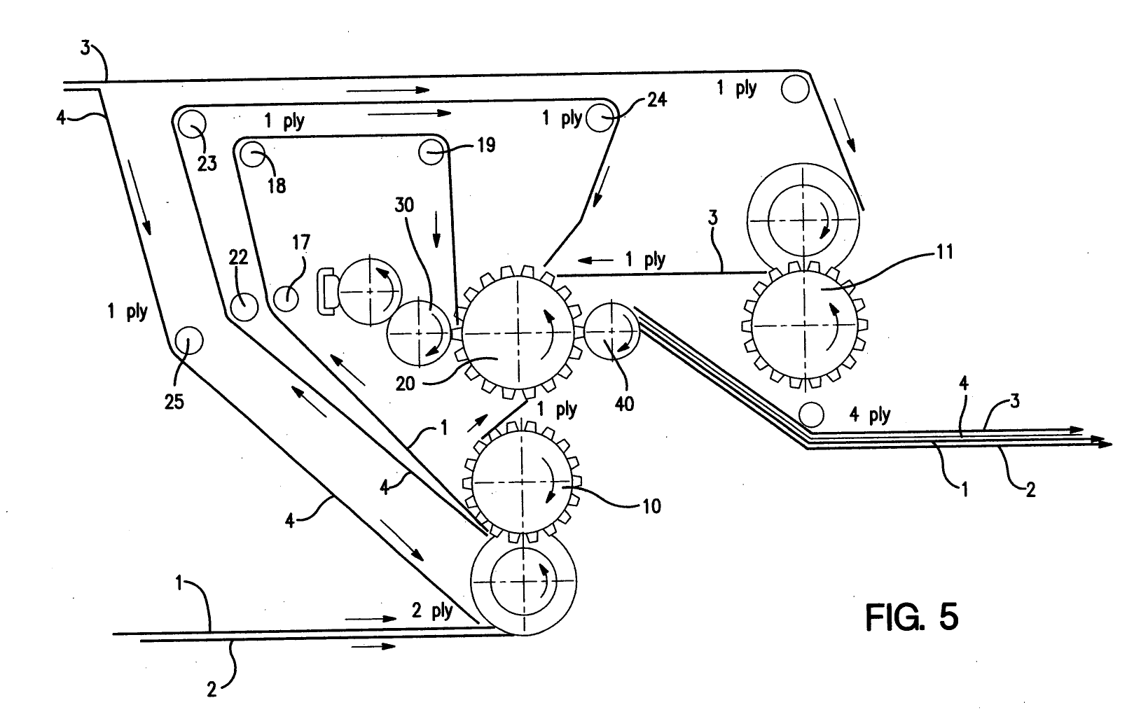

FIG. 5 shows, as a fifth embodiment, a similar arrangement to that of FIG. 4 wherein, however, ply 1 is directed to the glue application roll 30 by means of deviating rolls 17, 18 and 19, whereas ply 4, after having been embossed together with plies 1 and 2, is fed directly to the design roll 20 by means of deviating rolls 22, 23 and 24.

FIG. 6 shows in detail how at least two plies, after having been embossed together, are displaced relatively to each other according to the invention. The maximum distance D in the displacement direction between an embossing protrusion of the first ply 1 and an embossing protrusion of the second ply 2 is set as a function of the height H of the embossing protrusions and the length L of the embossing protrusions in the displacement direction of the two plies 1, 2, so that D is equal to the smaller one of the values of 12H and 14L.

Of course, the same may apply to other combinations of plies, for example to plies 3 and 4 in the embodiments of FIGS. 2 and 3. Additionally, the distance D is preferably equal to the smaller one of the values of 8H and 10L or, most preferably, 6H and 8L to provide a most simple and reliable process of increasing bulk of laminated tissue paper.

The embossed tissue paper has a base plane, i.e. the plane of the unembossed parts of the paper, and embossing protrusions protruding therefrom. The height H of the embossing protrusions from the base plane to the top of the protrusion may be measured by means of a so-called UBM measuring method such as disclosed in WO-A-00/63489, which is incorporated herein by reference. According to such a method, a cross section of the paper is measured. The length L of the protrusions is measured in the base plane.

Preferably, the two plies should at least be displaced so that the protrusions of the one ply are arranged opposite to unembossed surface areas of the other ply. It is, however, possible, to arrange just a part, but preferably at least about 25% up to about 50%, of each protrusion of one ply over an unembossed area of the respective other ply. Additionally, while displacement in the direction of displacement of the paper plies through the embossing nips (machine direction) has been described, in accordance with the present invention, also displacement in the transverse (cross machine) direction is meant, in addition to or alternatively to the machine direction.

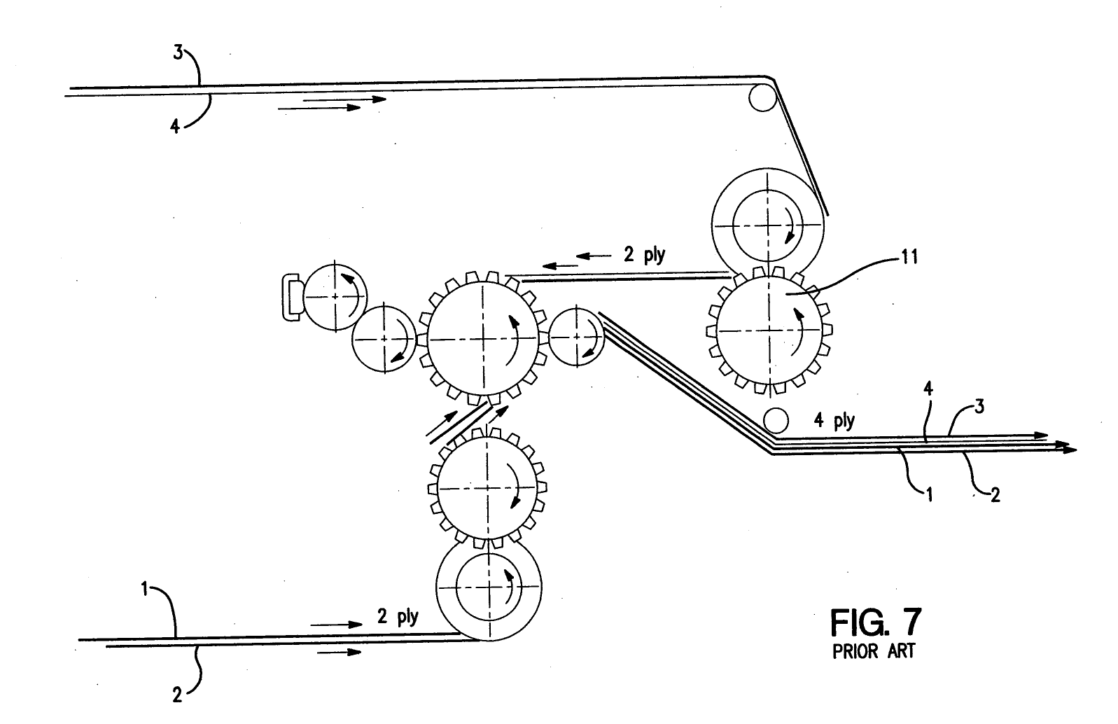

Finally, FIG. 7 shows a known apparatus for embossing and combining four plies of tissue. Contrary to the process according to the invention, plies 1, 2 and 3, 4, respectively, are not separated after having been embossed in combination, so that there is less bulk created than in the process according to the invention explained above with reference to FIGS. 1 to 6.

Table 1 shows some comparative examples of tissues manufactured according to the invention in an apparatus according to one of the FIGS. 1 to 5, and in an apparatus according to FIG. 7, without separating and displacing the plies.

The abbreviations in the column “base tissue” have the following meaning, the base tissues being manufactured by SCA Hygiene Products GmbH, Mannheim, Germany:

S1: (Toilet paper brand “Zewa Soft” quality) 2 ply/Com.No: 1030

S2: BSQ-A (Strong quality) 2 ply/ComNo: 1238

C1: BSQ-A Prelotioned Toilet Paper 15[g/m²]

The column “embossing combination” shows which embossing and design rolls were used, the embossing designs being those used by SCA Hygiene Products GmbH, Mannheim, Germany:

1: Ebonit roll (Goffra Feather design) (as design roll 20)

2: Steel roll (Micro embossing 40 dots per cm² design) (as top embossing roll 11)

3: Steel roll (Micro embossing 25 dots per cm² design) (as top embossing roll 11)

4: Steel roll (waffle design) (as bottom embossing roll 10)

5: Steel roll (Union 6409 design) (as bottom embossing roll 10)

6: Steel roll (Micro embossing 60 dots per cm² design) (as top embossing roll 11)

TABLE 1
Tissues produced according to the invention (FIGS. 1 to 5)
and according to the prior art (FIG. 7)

| | | | | | | | Top (Ebonit) | Bottom | Top | | | | |
|---|---|---|---|---|---|---|---|---|---|---|---|---|---|
| | | | | | | | embossing | (Waffle) | (Micro) | | | | |
| Sam- | | Amount | | | | | pressure | embossing | embossing | | Roll | Number | Sheet |
| ple | Base | of | Embossing | Production | Ply | Marrying | (design roll) | pressure | pressure | | diameter | of | length |
| No. | tissue | samples | combination | method | count | bar | bar | bar | bar | Tension | mm | sheets | mm |
| 1 | S1/S2 | 15 | 1/2/5 | | 4 | 1.5 | — | 3 | 4 | 500 | 122 | 150 | 125 |
| | | | | (prior | | | | | | | | | |
| | | | | art) | | | | | | | | | |
| 2 | S1/S2 | 15 | 1/2/5 | | 4 | 1.5 | — | 3 | 4 | 500 | 125-126 | 150 | 125 |
| 3 | S1/S2 | 15 | 1/2/5 | | 4 | 1.5 | — | 3 | 4 | 500 | 130-131 | 150 | 125 |
| 4 | S1/S2 | 15 | 1/2/5 | | 4 | 1.5 | — | 3 | 4 | 500 | 127 | 150 | 125 |
| 5 | S1/S2 | 15 | 1/2/5 | | 4 | 1.5 | — | 3 | 4 | 500 | 137 | 150 | 125 |
| 6 | S1/S2 | 15 | 1/2/5 | | 4 | 1.5 | — | 3 | 4 | 500 | 125 | 125 | 125 |
| 7 | S1/S2 | 15 | 1/2/5 | | 4 | 1.5 | — | 3 | 4 | 500 | 137 | 125 | 125 |
| 8 | S1/S2 | 15 | 1/3/5 | | 4 | 1.5 | — | 3 | 4 | 500 | 131 | 150 | 125 |
| 9 | S1/S2 | 15 | 1/3/5 | | 4 | 1.5 | — | 3 | 4 | 500 | 150 | 150 | 125 |
| 10 | S1/S2 | 15 | 1/3/5 | | 4 | 1.0 | — | 3 | 4 | 500 | ca. 155 | 125 | 125 |
| 11 | C1/C1 | 15 | 1/3/5 | | 4 | 1.5 | — | 3 | 4 | 500 | 134 | 125 | 125 |
| 12 | S1/S2 | 15 | 1/6/5 | | 4 | 1.5 | — | 3 | 4 | 500 | 124 | 150 | 125 |
| | | | | (prior | | | | | | | | | |
| | | | | art) | | | | | | | | | |
| 13 | S1/S2 | 15 | 1/6/5 | | 4 | 1.5 | — | 3 | 4 | 500 | 129-130 | 150 | 125 |
| 14 | S1/S2 | 15 | 1/3/4 | | 4 | 1.5 | — | 3 | 4 | 500 | 134 | 150 | 125 |
| | | | | (prior | | | | | | | | | |
| | | | | art) | | | | | | | | | |
| 15 | S1/S2 | 12 | 1/3/4 | | 4 | 1.5 | — | 3 | 4 | 500 | 146 | 150 | 125 |

The inventive process will, in a simple way, increase the bulk of the tissue paper. However, even if all the other parameters in the process are kept the same, the result will not automatically be a bigger finished roll. This is especially true if the winding machine is configured to make rolls of a certain length with a certain diameter. In such a case, however, the roll firmness will be higher than with a roll when the embossing has not been displaced. If, however, the winding tension is decreased, the same length of paper will give a higher roll diameter or a smaller amount paper will give the same roll diameter than a roll in which the paper has not been displaced.

In one example a prior art 21 meter of paper was made into a roll with a width of 125 cm by a roll firmness of 86% while according to the invention 18 m was enough to make a roll on the same diameter and roll firmness. This may not seem much if one do not take into consideration the amount of tissue paper that is sold every year.

The example above was made for roll products such as rolled toilet paper and household towels. This invention is of course useful also for tissue paper types that are not rolled but folded, e.g. handwipes, handkerchiefs and serviettes. In all products, the higher bulk achieved gives a higher sensation of bulk softness, a critical feature for the feel of softness. Furthermore, this increase in thickness also results in a textile-like appearance, a very desired feature of high quality tissue paper products.

All of what has been said above in respect of tissue paper, of course, also applicable for non-woven materials, such as wipes or similar products.

The embossing patterns falling within the scope of the present invention can be of any conventional design. The embossing protrusions have dimensions ususally up to about 5 mm in the machine and cross machine directions. However, certain embossing patterns can also have dimensions up to about 20 mm in length in the machine direction and about 2 mm in the cross machine direction. Additionally, the embossing protrusions can extend at an angle to the machine direction. The height of the embossing protrusions can be about 1 mm to 2 mm. Naturally, however, the dimensions and shapes of the embossing protrusions are not limited to the examples given and are well known in the art.

The plies of the laminated tissue paper and the laminated tissue paper product may be plybonded with mechanical or adhesive plybonding as known in the art. Mechanical plybonding as known in the art can be achieved by application of a high pressure, e.g. in an additional embossing nip. Another way that is not so common is to use, ultrasonic welding for plybonding, a method that is explained in the U.S. pending provisional patent application No. 60/341803. In the case of adhesive plybonding, the glue can, for example, be added to all the protrusions of one ply or with a structured glue application roller to just some of the protrusions. Furthermore, in the case of adhesive embossing, the paper can also be further embossed in a further embossing nip, for example by giving the paper an embossed spot pattern. In this case, often only the spot protrusions will be covered with glue and will be the part that bonds to the other plies.

1. Process for laminating plies of tissue paper, which comprises
combining and embossing at least two plies of tissue paper together in at least one embossing nip so that the plies are provided with substantially identical embossing patterns which consist of embossing protrusions,
separating the embossed plies to obtain separated plies, and
displacing and recombining the separated plies relative to each other, with the embossing protrusions of the plies extending in the same direction, to form a laminated tissue paper,
wherein the displacing and recombining step is performed such that, in the laminated tissue paper, the maximum distance D in the displacement direction between an embossing protrusion of a first ply and an embossing protrusion of a second ply, which is displaced relative to said first ply, is set as a function of the height H of the embossing protrusions and the length L of the embossing protrusions in the displacement direction of the two plies, so that D is equal to the smaller one of the values of 12H and 14L.

2. Process as claimed in claim 1, wherein D is equal to the smaller one of the values of 8H and 10L.

3. Process as claimed in claim 1, wherein D is equal to the smaller one of the values of 6H and 8L.

4. Process as claimed in claim 1, wherein at least one further tissue ply is superposed to the laminated tissue paper.

5. Process as claimed in claim 4, wherein the at least one further tissue ply is also a recombined tissue paper manufactured in the process.

6. Process as claimed in claim 1, wherein the plies are laminated by at least one of mechanical ply bonding and adhesive ply bonding.

7. Process as claimed in claim 6, wherein mechanical ply bonding is achieved by high pressure or ultrasonic welding.

8. Process as claimed in claim 6, wherein adhesive ply bonding is achieved by covering at least some of the protrusions of at least one of the plies with glue before the plies are recombined.

9. Process as claimed in claim 6, wherein adhesive ply bonding is achieved by applying glue in narrow strips along an edge of at least one of the tissue plies.

10. Process as claimed in claim 1, wherein the displacement of the separated plies relative to each other is effected in the direction of movement of the paper plies through the at least one embossing nip.

11. Process as claimed in claim 1, wherein the displacement of the separated plies relative to each other is effected in a direction transverse to the movement of the paper plies through the at least one embossing nip.

12. Laminated tissue paper comprising at least two plies with substantially identical embossing patterns, said embossing patterns consisting of embossing protrusions, wherein said at least two plies are displaced relatively to each other in a displacement direction, and laminated with the protrusions of the plies extending in the same direction, and the maximum distance D in the displacement direction between an embossing protrusion of a first ply and an embossing protrusion of a second ply, which is displaced relative to the first one, is set as a function of the height H of the embossing protrusions and the length L of the embossing protrusions in the displacement direction so that D is equal to the smaller one of the values of 12H and 14L.

13. Laminated tissue paper as claimed in claim 12, wherein D is equal to the smaller one of the values of 8H and 10L.

14. Laminated tissue paper as claimed in claim 12, wherein D is equal to the smaller one of the values of 6H and 8L.

15. Laminated tissue paper as claimed in claim 12, comprising at least one further tissue ply which is superimposed to the laminated tissue paper.

16. Laminated tissue paper as claimed in claim 15, wherein the at least one further tissue ply is another laminated tissue paper.

17. Process as claimed in claim 12, wherein the plies are laminated by at least one of mechanical ply bonding and adhesive ply bonding.

18. Laminated tissue paper as claimed in claim 15, wherein the at least one further tissue ply is also a laminated tissue paper comprising at least two plies with substantially identical embossing patterns, said embossing patterns consisting of embossing protrusions, wherein said at least two plies are displaced relatively to each other in a displacement direction, and laminated with the protrusions of the plies extending in the same direction, and the maximum distance D in the displacement direction between an embossing protrusion of a first ply and an embossing protrusion of a second ply, which is displaced relative to the first one, is set as a function of the height H of the embossing protrusions and the length L of the embossing protrusions in the displacement direction so that D is equal to the smaller one of the values of 12H and 14L.
